(19) United States
(12) Patent Application Publication
(10) Pub. No.: US 2013/0115528 A1
(43) Pub. Date: May 9, 2013

(54) RECHARGEABLE ANION BATTERY CELL USING A MOLTEN SALT ELECTROLYTE

(71) Applicant: CHUN LU, Sewickley, PA (US)

(72) Inventor: CHUN LU, Sewickley, PA (US)

(21) Appl. No.: 13/289,374

(22) Filed: Nov. 4, 2011

(51) Int. Cl. H01M 12/08

(52) U.S. Cl. 429/405

(57) ABSTRACT

A rechargeable electrochemical battery cell comprises a molten carbonate salt electrolyte (32) whose anion transports oxygen between a metal electrode (34) and an air electrode (30) on opposite sides of the electrolyte (32), where the said molten salt electrolyte (32) is retained inside voids of a porous electrolyte supporting structure sandwiched by the said electrodes, and the molten salt comprises carbonate including at least one of the alkaline carbonate including Li₂CO₃, Na₂CO₃, and K₂CO₃, having a melting point between 400° C. and 800° C.

### BACKGROUND OF THE INVENTION

1. Field of the Invention

This present invention relates to a rechargeable electrochemical anion battery cell, which uses a molten salt electrolyte, preferably containing carbonate ion (CO₃²⁻).

2. Related Art

Electrical energy storage is crucial for the effective proliferation of an electrical economy and for the implementation of many renewable energy technologies. During the past two decades, the demand for the storage of electrical energy has increased significantly in the areas of portable, transportation, and load-leveling and central backup applications.

The present electrochemical energy storage systems are simply too costly to penetrate major new markets, still higher performance is required, and environmentally acceptable materials are preferred. Transformational changes in electrical energy storage science and technology are in great demand to allow higher and faster energy storage at the lower cost and longer lifetime necessary for major market enlargement. Most of these changes require new materials and/or innovative concepts with demonstration of larger redox capacities that react more rapidly and reversibly with cations and/or anions.

Batteries range in size from button cells used in watches, to megawatt loading leveling applications. They are, in general, efficient storage devices, with output energy typically exceeding 90% of input energy, except at the highest power densities. Rechargeable batteries have evolved over the years from lead-acid through nickel-cadmium and nickel-metal hydride (“NiMH”) to lithium-ion batteries. NiMH batteries taught, for example, in U.S. Pat. No. 6,399,247 B1 (Kitayama), were the initial workhorse for electronic devices such as computers and cell phones, but they have almost been completely displaced from that market by lithium-ion batteries, taught for example by U.S. Pat. No. 7,396,612 B2 (T. Ohata et al.) because of the latter's higher energy storage capacity. Today, NiMH technology is the principal battery used in hybrid electric vehicles, but it is likely to be displaced by the higher power energy and now lower cost lithium-ion batteries, if the latter's safety and lifetime can be improved. Of the advanced batteries, lithium-ion is the dominant power source for most rechargeable electronic devices.

What is needed is a dramatically new electrical energy storage device that can easily discharge and charge a high capacity of energy quickly and reversibly, as needed. What is also needed is a device that is simple and that can operate for years without major maintenance. It is a main object to provide a new and improved electrochemical battery that is easy to charge and discharge and has low maintenance. One possibility is a rechargeable oxide-ion battery (ROB) set out in U.S. Application Publication No. U.S. 2011/0033769A1 (Huang et al.) and U.S. application Ser. No. 12/850,086 (Huang et al.), filed on Aug. 4, 2010. A ROB comprises a metal electrode, an oxide-ion conductive electrolyte, and a cathode. The metal electrode undergoes reduction-oxidation cycles during charge and discharge processes for energy storage. For example, in discharging mode, the metal is oxidized: yMe+x/2O₂=Me_{y}Oₓ and is reduced in charging mode: Me_{y}Oₓ=yMe+x/2O₂, where Me=metal.

Molten carbonate fuel cells (“MCFC”) are well known in the art and convert chemical energy into direct current electrical energy, typically at temperatures above about 450° C. This temperature is required to melt carbonate and render electrolyte sufficiently conductive. Alkaline carbonate is a prime electrolyte. Such fuel cells are taught, for example, by U.S. Pat. Nos. 4,895,774 and 4,480,017 (Ozhu et al. and Takeuchi et al, respectively). The general working principles and general reactions of a MCFC are shown in prior art FIG. 1, where anode 12, electrolyte 14, cathode 16 and load 18 are shown, along with the electrochemical reactions. Here, carbon dioxide (CO₂) and oxygen (in air, for example) are reduced into carbonate ion (CO₃²⁻) by the reaction: CO₂+1/2O₂+2e⁻=CO₃²⁻. The CO₃²⁻ migrates to a fuel electrode, anode 12, through a molten carbonate electrolyte 14, and reacts with provided fuel (that is, H₂), by the reaction CO₃²⁻+H₂→H₂O+CO₂. Therefore, the overall reaction is H₂+1/2O₂═H₂O.

Although a MCFC is able to convert chemical energy of fuel into electrical energy, operated in the temperature range of between 500° C. and 700° C., it is incapable of storing energy by converting electrical energy into chemical energy. Therefore, there is a need to design a rechargeable battery based on carbonate ion for energy storage. This invention describes a rechargeable battery cell in which CO₃²⁻ is used as a shuttle media to reversibly transport electronic charges between negative and positive electrodes. In addition, the configurations and materials employed in such a battery are also depicted.

### SUMMARY OF THE INVENTION

The above needs are met and object accomplished by providing rechargeable anion battery cells, using a molten salt electrolyte whose anion transports CO₃²⁻ between a metal electrode and an air electrode on opposite sides of the molten salt electrolyte. The carbonate ion (CO₃²⁻) in a molten state is transferred between electrodes on either side of the electrolyte, with the overall reaction of y/2O₂+xMe⇄MeₓO_{y}, where Me=metal.

This is provided by an electrochemical battery cell which comprises an air electrode where reduction-oxidation reaction between oxygen and carbonate ion takes place; a metal electrode where a carbonate ion interacts with metal for releasing/capturing oxygen during discharging/charging operation, respectively; and a molten salt electrolyte disposed between the said air electrode and metal electrode, and including a porous retaining material structured for accommodating the molten salt, where the overall reaction is y/2O₂+xMe⇄MeₓO_{y}, where y=1 to 5 and x=1 to 4.

### BRIEF DESCRIPTION OF THE DRAWINGS

For a better understanding of the invention, reference may be made to the preferred embodiments exemplary of this invention, shown in the accompanying drawings in which:

FIG. 1 illustrates the operation principles, generally, of prior art molten carbonate fuel cells;

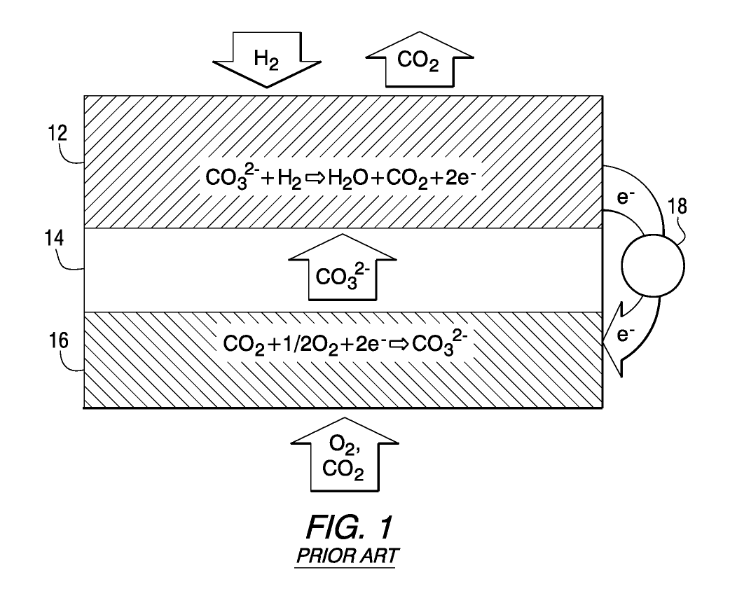

FIG. 2 illustrates the working principles of a rechargeable oxide-ion battery (ROB) cell; and

FIG. 3 is a schematic illustration of the electrochemical battery of this invention, using molten salt electrolyte.

### DESCRIPTION OF THE PREFERRED EMBODIMENT

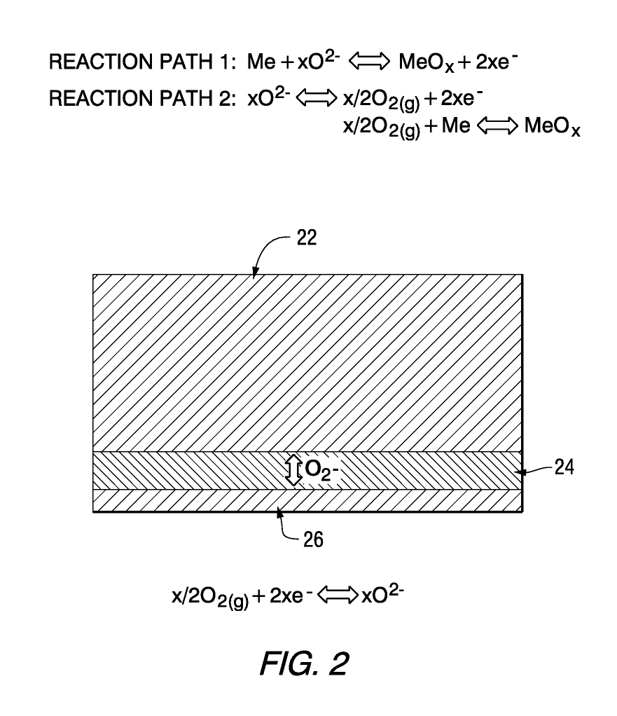

The working principles of a rechargeable oxide-ion battery (ROB) cell are schematically shown in FIG. 2, where metal electrode (anode) 22, electrolyte 24 and air electrode (cathode) 26 are shown. In discharge mode, oxide-ion anions migrate from the high partial pressure oxygen side (air electrode 26) to the low partial pressure oxygen side (metal electrode 22) under the driving force of gradient of oxygen chemical potential. There exist two possible reaction mechanisms to oxidize the metal. One of them, as designated as Path 1, is that oxide ion can directly electrochemically oxidize metal to form a metal oxide. The other, as designated as Path 2, involves generation and consumption of gaseous phase oxygen. The oxide ion can be initially converted to gaseous oxygen molecules on the metal electrode, and then further reacted with metal via a solid-gas phase mechanism to form metal oxide. In charge mode, the oxygen species, released by reducing metal oxide to metal via electrochemical Path 1 or solid-gas mechanism Path 2, are transported from the metal electrode back to the air electrode.

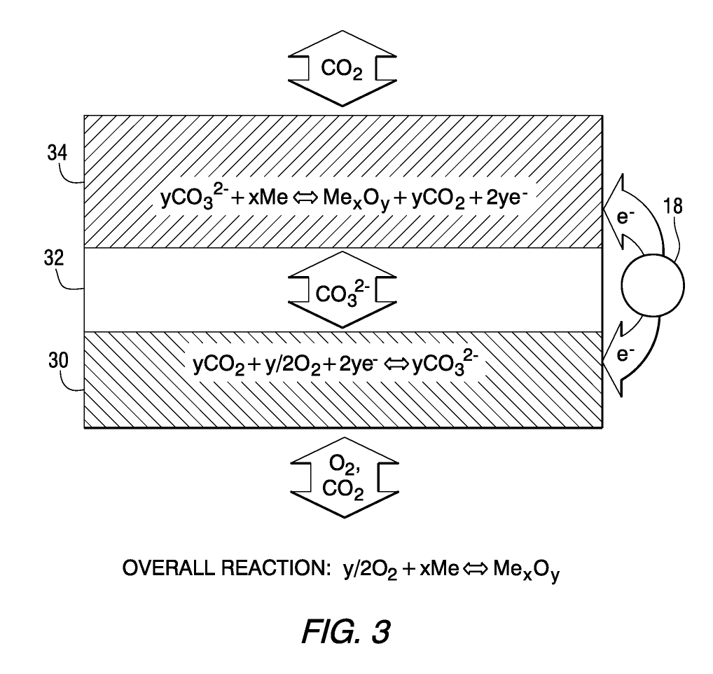

FIG. 3 illustrates the operational principles of the invented electrochemical battery of this invention based on CO₃²⁻ ion, consisting of an air electrode 30, molten salt electrolyte 32, and a metal electrode 34, with interaction of metal electrode ⇄CO₂, and air electrode 30 with O₂, CO₂ exit entry. Retained inside voids of a porous electrolyte supporting structure, which is sandwiched by the electrodes 30 and 34, the molten salt 32 comprises carbonate mixture of Li₂CO₃ and at least one alkaline carbonate selected from the group consisting of Na₂CO₃ and K₂CO₃. These alkaline carbonates, as electrolyte, have a melting point between 400° C. and 800° C. In discharging mode, the CO₃²⁻ ion, generated by the reduction reaction of yCO₂+y/2O₂+2ye⁻→yCO₃²⁻ on the air electrode where y=1-5, diffuses through molten salt and reaches the metal electrode where it oxidizes metal of the metal electrode following the reaction of yCO₃²⁻+xMe→MeₓO_{y}+yCO₂+2ye⁻, where Me=a metal of the metal electrode selected from the group consisting of Sc, Y, La, Ti, Zr, Hf, Ce, Cr, Mn, Fe, Co, Ni, Cu, Nb, Ta, V, Mo, Pd and W and where y=1-5 and x=1-4.

The total discharging reaction of the invention is expressed as y/2O₂+xMe MeₓO_{y}. In the charging mode, the metal oxide is reduced back into metal, by the reaction MeₓO_{y}→y/2O₂+xMe. On the metal electrode, the metal oxide is reduced following the reaction of MeₓO_{y}+yCO₂+2ye⁻→yCO₃²⁻+xMe. The produced CO₃²⁻ ion reverses back to the air electrode and forms CO₂ and O₂ by the reaction of yCO₃^{2-→yCO}₂+y/2O₂+2ye⁻. A discharging-charging cycle essentially is the metal oxidation and reduction reaction of y/2O₂+xMe⇄MeₓO_{y}, which is utilized for releasing and capturing electrical charges for energy storage, respectively.

In the invention, the anion of a molten salt (CO₃²⁻) is a carrier for transporting oxygen between the electrodes. The preferred molten salt is an alkali carbonate mixture of (Li₂CO₃) and at least one material selected from the group consisting of sodium carbonate (Na₂CO₃), and potassium carbonate (K₂CO₃). These alkali carbonate mixtures can preferably be transformed producing an eutectic molten salt when its composition ratio is constituted by about 62 mol % of Li₂CO₃ and about 38 mol % of K₂CO₃. The electrolyte is contained in a porous retaining material preferably selected from the group consisting of lithium aluminate, lithium zirconate and stabilized zirconia.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A rechargeable battery cell which comprises:
a) an air electrode;
b) a metal electrode;
c) a molten salt electrolyte disposed between the said air electrode and metal electrode and including a porous retaining material structured for accommodating carbonate ion in a molten salt state, wherein at the air electrode a reduction-oxidation reaction between oxygen and carbonate ion takes place; and at the metal electrode, carbonate ion interacts with metal for releasing/capturing oxygen during discharging/charging operation, respectively.

2. The rechargeable battery cell of claim 1, wherein anion of the molten salt is a carrier for transporting oxygen between said electrodes of claim 1.

3. The rechargeable battery cell of claim 1, wherein the molten salt electrolyte comprises an alkali carbonate mixture of lithium carbonate Li₂CO₃ and at least one material selected from the group consisting of sodium carbonate Na₂CO₃, and potassium carbonate K₂CO₃.

4. The rechargeable battery cell of claim 3, wherein the alkali carbonate mixture has a melting point between 400° C. and 800° C.

5. The rechargeable battery cell of claim 3, wherein the electrolyte consists essentially of Li₂CO₃ and K₂CO₃.

6. The rechargeable battery cell of claim 4, wherein the alkali carbonate mixture can be transformed producing an eutectic molten salt when its composition ratio is constituted by 62 mol % of Li₂CO₃ and 38 mol % of K₂CO₃.

7. The rechargeable battery cell of claim 1, wherein the porous retaining material for the electrolyte is made of at least one material selected from the group consisting of lithium aluminate, lithium zirconate and stabilized zirconia.

8. The rechargeable battery cell of claim 1, wherein the metal of the metal electrode is selected from the group consisting of Sc, Y, La, Ti, Zr, Hf, Ce, Cr, Mn, Fe, Co, Ni, Cu, Nb, Ta, V, Mo, Pd and W.

9. The rechargeable battery cell of claim 1, wherein the reaction at the metal electrode is yCO₃²⁻+ₓMe⇄Meₓ0_{y}+yCO₂+2ye⁻, where y=1-5 and x=1-4.

10. The rechargeable battery cell of claim 1, wherein the reaction at the air electrode is yCO₂+y/2O₂+2ye⁻⇄yCO₃²⁻, where y=1-5.
